(19) United States
(12) Patent Application Publication
(10) Pub. No.: US 2022/0027409 A1
(43) Pub. Date: Jan. 27, 2022

(54) ENTITY TO VECTOR REPRESENTATION FROM GRAPHS IN A COMPUTING SYSTEM

(71) Applicant: VMware, Inc., Palo Alto, CA (US)

(72) Inventors: Srilakshmi LINGAMNENI, Fremont, CA (US); Barak RAZ, Palo Alto, CA (US); Bin ZAN, Santa Clara, CA (US); Zhen MO, Palo Alto, CA (US); Vijay GANTI, Fremont, CA (US)

(21) Appl. No.: 16/937,417

(22) Filed: Jul. 23, 2020

(51) Int. Cl. G06F 16/901; G06F 16/28; H04L 12/24; H04L 29/12; G06K 9/62

(52) U.S. Cl. CPC G06F 16/9024; G06F 16/288; G06K 9/628; H04L 61/2007; H04L 41/142

(57) ABSTRACT

An example method of representing a selected entity in a plurality of entities in a computing system includes: obtaining a graph representation of the plurality of entities, the graph representation having nodes and edges representing a hierarchy of the plurality of entities; extracting a set of paths from the graph representation, each path in the set of paths including a series of edge-connected nodes in the graph representation; processing the set of paths to generate a vector representation of the selected entity, the vector representation having a plurality of elements representing a context of the selected entity within the graph representation; and providing the vector representation as input to an application executing in the computing system.

### BACKGROUND

A computer system has multiple processes executing thereon that accomplish various tasks. Some processes are intrinsic to an operating system (OS), while other processes are related to specific services or applications. A computer system may further be virtualized by executing multiple virtual machines (VMs) managed by a hypervisor. Each VM can provide a specific service or accomplish a specific task. A computer system, including a virtualized computing system, can be connected to a network and utilize multiple Internet Protocol (IP) addresses to perform certain tasks and behave in a specific manner. Generating mathematical representations of various entities in a computer system, such as processes, VMs, IP addresses, and the like, in a form that captures the context information effectively and efficiently is desired. Such representation enables applications to perform various analyses, such as entity role identification, finding similar entities within the computer system, modeling, and the like.

### SUMMARY

In an embodiment, a method of representing a selected entity in a plurality of entities in a computing system includes: obtaining a graph representation of the plurality of entities, the graph representation having nodes and edges representing a hierarchy of the plurality of entities; extracting a set of paths from the graph representation, each path in the set of paths including a series of edge-connected nodes in the graph representation; processing the set of paths to generate a vector representation of the selected entity, the vector representation having a plurality of elements representing a context of the selected entity within the graph representation; and providing the vector representation as input to an application executing in the computing system.

Further embodiments include a non-transitory computer-readable storage medium and a computing system comprising instructions that cause a computer system to carry out the above method.

### BRIEF DESCRIPTION OF THE DRAWINGS

FIG. 1 is a block diagram of a virtualized computing system in which embodiments described herein may be implemented.

FIG. 2 is a block diagram illustrating a logical process of entity-to-vector conversion according to an embodiment.

FIG. 3 illustrates an example of a graph description for a set of entities.

FIG. 4 is a flow diagram depicting a method of representing entities in a computing system according to an embodiment.

FIG. 5 shows a table of processes and corresponding metadata according to an embodiment.

FIG. 6 depicts an invocation graph for a set of processes according to an embodiment.

FIG. 7 depicts an example conversion of a process into a vector according to an embodiment.

FIG. 8 depicts a table showing comparison of a process with other processes to determine similarity according to an example.

### DETAILED DESCRIPTION

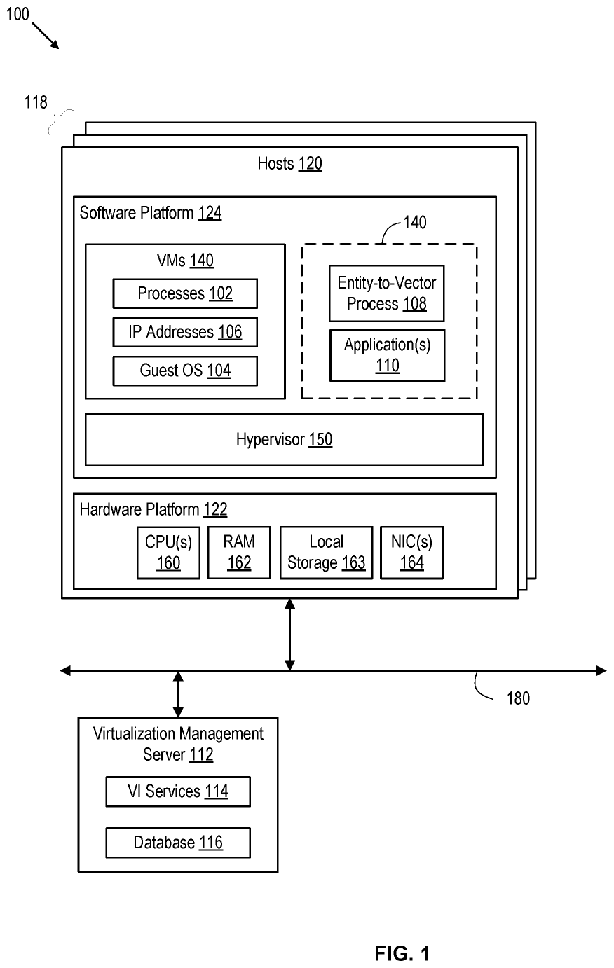

FIG. 1 is a block diagram of a virtualized computing system 100 in which embodiments described herein may be implemented. It should be noted that while certain embodiments are described with respect to a virtualized computing system, the embodiments may similarly instead be used for a physical computing system. System 100 includes a cluster of hosts 120 (“host cluster 118”) that may be constructed on server-grade hardware platforms such as an x86 architecture platforms. For purposes of clarity, only one host cluster 118 is shown. However, virtualized computing system 100 can include many of such host clusters 118. Further, while a host cluster 118 is shown by way of example, the techniques described herein can be executed on a single, non-clustered host.

As shown, a hardware platform 122 of each host 120 includes conventional components of a computing device, such as one or more central processing units (CPUs) 160, system memory (e.g., random access memory (RAM) 162), one or more network interface controllers (NICs) 164, and optionally local storage 163. CPUs 160 are configured to execute instructions, for example, executable instructions that perform one or more operations described herein, which may be stored in RAM 162. NICs 164 enable host 120 to communicate with other devices through a physical network 180. Physical network 180 enables communication between hosts 120 and between other components and hosts 120 (other components discussed further herein). Local storage 163 may comprise magnetic disks, solid-state disks, flash memory, and the like as well as combinations thereof. In some embodiments, local storage 163 in each host 120 can be aggregated and provisioned as part of a virtual storage area network (SAN).

A software platform 124 of each host 120 provides a virtualization layer, referred to herein as a hypervisor 150, which directly executes on hardware platform 122. In an embodiment, there is no intervening software, such as a host operating system (OS), between hypervisor 150 and hardware platform 122. Thus, hypervisor 150 is a Type-1 hypervisor (also known as a “bare-metal” hypervisor). As a result, the virtualization layer in host cluster 118 (collectively hypervisors 150) is a bare-metal virtualization layer executing directly on host hardware platforms. Hypervisor 150 abstracts processor, memory, storage, and network resources of hardware platform 122 to provide a virtual machine execution space within which multiple virtual machines (VM) may be concurrently instantiated and executed. One example of hypervisor 150 that may be configured and used in embodiments described herein is a VMware ESXi™ hypervisor provided as part of the VMware vSphere® solution made commercially available by VMware, Inc. of Palo Alto, Calif.

Each of VMs 140 includes a guest operating system (OS) 104, which can be any known operating system (e.g., Linux®, Windows®, etc.). Processes 102 execute in VMs 140 managed by guest OS 104. VMs 140 include Internet Protocol (IP) addresses 106 for networked communication (e.g., between VMs 140 and/or between VMs 140 and external systems over physical network 180).

In embodiments, virtualized computing system 100 includes an entity-to-vector process 108 and application(s) 110. Entity-to-vector process 108 and application(s) 110 comprise software executing on hardware platform 122. In embodiments, entity-to-vector process 108 and application(s) 110 execute within VM(s) 140 (e.g., the same or different VMs). Other embodiments include one or both of entity-to-vector process 108 and application(s) 110 executing outside of VMs 140, such as in hypervisor 150 (i.e., directly on hardware platform 122) or in other host(s) outside of host cluster 118.

In embodiments, virtualized computing system 100 includes a virtualization management server 112 configured to manage host cluster 118. Virtualization management server 116 can include virtualized infrastructure (VI) services 114 and a database 116. VI services 114 include various virtualization management services, such as a distributed resource scheduler (DRS), high-availability (HA) service, single sign-on (SSO) service, virtualization management daemon, and the like. DRS is configured to aggregate the resources of host cluster 118 to provide resource pools and enforce resource allocation policies. DRS also provides resource management in the form of load balancing, power management, VM placement, and the like. HA service is configured to pool VMs and hosts into a monitored cluster and, in the event of a failure, restart VMs on alternate hosts in the cluster. A single host is elected as a master, which communicates with the HA service and monitors the state of protected VMs on subordinate hosts. The HA service uses admission control to ensure enough resources are reserved in the cluster for VM recovery when a host fails. SSO service comprises security token service, administration server, directory service, identity management service, and the like configured to implement an SSO platform for authenticating users. The virtualization management daemon is configured to manage objects, such as data centers, dusters, hosts, VMs, resource pools, datastores, and the like. Database 116 stores various objects managed by VI services 114, including VMs, hosts, host clusters, resource pools, data centers (pluralities of host clusters), datastores, virtual networks, and the like. In embodiments, entity-to-vector process 108 and/or application(s) 110 can execute in virtualization management server 112.

Virtualized computing system 100 includes various entities. Entities encompass VMs 140, processes 102, IP addresses 106 (e.g., associated with virtual NICs of VMs 140), hosts 120, host cluster 118, and the like. Entities can be objects managed by virtualization management server 112, such as any object stored in database 116. Entities can be objects managed by hypervisor 150 or objects managed by a VM 140. Entities can have a hierarchical relationship (e.g., parent entities having child entities). For example, as described further herein, entities can be processes. The set can include a root process that spawns child processes. Child processes can spawn still other child processes and so on. A set of entities can be homogenous (e.g., a set of VMs) or heterogenous (e.g., a set of VMs and processes executing on the VMs). Information about entities (e.g., metadata) can be stored in a database (e.g., a relational database, graph database, etc.), such as database 116 or any database in a host 120 (e.g., a database managed by hypervisor 150 or a database in a VM 140). In the example of entities being processes, the information can include a table of processes having IDs, timestamps, names, parent IDs, etc. Information about entities can also be stored in other forms, such as tabular form (e.g., a table or list). The metadata for the entities can include information describing hierarchical relationships between the entities (e.g., which process invoked which other process).

In embodiments, application(s) 110 are configured to perform some function given a set of entities. Example applications 110 include health monitors, anomaly detectors, clustering tools, classification tools, or the like. For example, a health monitor can be configured to monitor health of VMs 140, hosts 120, host clusters 118, etc. An anomaly detector can be configured to monitor for anomalous processes 102 executing in virtualized computing system 100. Each application 110 can include a mathematical model configured to process vector descriptions of entities in order to perform its function. For example, a vector description of a process in an invocation graph can be used to identify unknown processes having similar or the same vector descriptions. In another example, vector descriptions of processes in an invocation graph can be used to identify similar processes or flag anomalous behavior of a specific process over time by computing similarity between two vectors. In embodiments, a vector description of an entity includes a set of numerical elements that represent the entity in a given graph description of entities. As discussed above, the information (metadata) for entities can be stored in tabular or database form, rather than vector form. Accordingly, entity-to-vector process 108 is configured to obtain the entity metadata, form a graph description (if necessary), and generate vector descriptions for selected entities based on the graph description. Entity-to-vector process 108 can store or otherwise provide vector descriptions of entities to application(s) 110 as parametric input. In embodiments, entity-to-vector process 108 can be part of one or more of application(s) 110, rather than a stand-alone process.

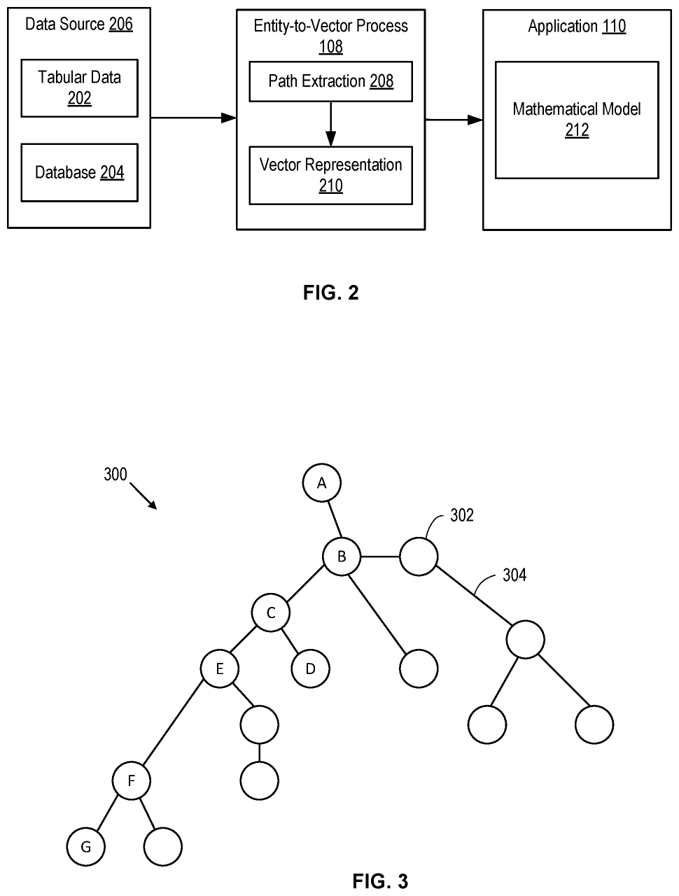

FIG. 2 is a block diagram illustrating a logical process of entity-to-vector conversion according to an embodiment. Entity-to-vector process 108 accesses a data source 206. Data source 206 includes entity metadata, which can be obtained from hypervisor 150, VMs 140, and/or virtualization management server 112. Entity metadata can be in various forms, including tabular data 202 and/or database 204 (e.g., a relational database, graph database, or the like).

Entity-to-vector process 108 includes path extraction 208 and vector representation 210 modules. Path extraction 208 receives a graph description of entities as input. In an embodiment, the graph description comprises a directed acyclic graph (DAG).

FIG. 3 illustrates an example of a graph description 300 for a set of entities. Graph description 300 (also referred to as graph representation) includes nodes 302 representing entities, and edges 304 between nodes. Graph description 300 defines a hierarchical relationship between entities. In the example, the entity labeled A represents a root of graph description 300 and an entity G represents a leaf of graph description 300. Graph description can include zero or more nodes in any path from the root to a leaf in graph description 300.

Returning to FIG. 2, path extraction 208 can obtain a graph description directly from data source 206 (e.g., a graph database) or can generate a graph description from entity metadata (e.g., from tabular data 202). In embodiments, the graph description can be captured at one instant in time. In other embodiments, the graph description can be captured over time (e.g., a first set of entity metadata can be combined with additional sets of entity metadata obtained over time to form a single graph description). For example, a current set of processes can be analyzed at one instrant in time and then analyzed at a later instant in time. During the time period, processes can spawn and/or be deleted. Thus, the invocation graph can change over time. Path extraction 208 is configured to generate a set of paths in graph description 300. In an embodiment, the set of paths consists of all possible paths in graph description 300 starting from the root. Each path in graph description is a list of entities (a list of nodes in the graph). In the example of FIG. 3, one path is A-B-C-D and another path is A-B-C-E-F-G. A given graph description can include any number of paths. Each path includes a plurality of nodes in the graph. Path extraction 208 outputs the set of paths. The set of paths can be considered as a corpus of paths, where the paths are equivalent to sentences in a language corpus and entities are equivalent to words in the sentences.

Vector representation 210 receives the set of paths output by path extraction 208. Vector representation 210 executes an algorithm to convert selected entities (e.g., one or more of the entities in graph description 300) into vector descriptions using the set of paths as training data. Example algorithms executed by vector representation 210 include Continuous Bag of Words, Skip-gram, GloVe, and the like. A vector representation of an entity includes a plurality of elements. In embodiments, each element in a vector representation is a number, such as a real number, integer, or the like. A vector representation captures context for a given entity from graph description 300 and represented in numerical form. An example invocation graph and its conversion to vector representations are described below.

Application 110 receives vector descriptions of entities from entity-to-vector process 108. Application 110 can include a mathematical model 212 configured to process the vector descriptions in order to perform some function of the entities (e.g., classification, monitoring, anomaly detection, clustering, etc.). For example, entities having a similar context in graph description will have similar vector representations. Application 110 can identify, group, classify, etc. similar entities based on their vector representations. For example, similarity or dissimilarity can be determined based on how similar or dissimilar two vectors are mathematically. In another example, vector representations of entities can be compared with a base set of vector representations to detect anomalies in the entities. For example, vectors for an invocation graph can be compared against a set of expected vectors. Dissimilarities between the determined vectors and the expected vectors can indicate an anomaly in the invocation graph (e.g., a malfunction, malware, etc.). Mathematical model 212 can detect similarities, differences, anomalies, etc. in entities that is not readily apparent from entity metadata or the graph description of the entities.

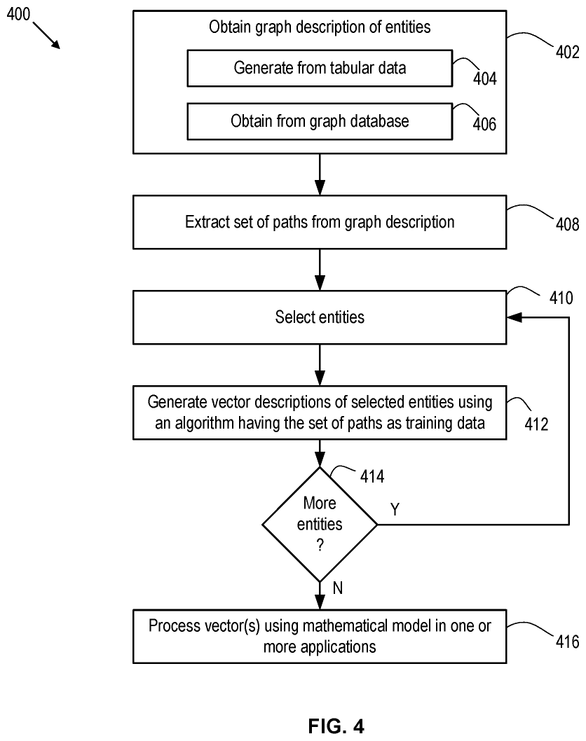

FIG. 4 is a flow diagram depicting a method 400 of representing entities in a virtualized computing system 100 according to an embodiment. Method 400 can be performed by software executing in virtualized computing system 100, which comprises software executing on CPU, memory, storage, and network resources managed by a virtualization layer (e.g., a hypervisor) or a host OS. In certain embodiments, method 400 could similarly be used to represent entities of a physical computing system. In certain embodiments, method 400 and be performed by, for example, a memory storing software that executes on a processor of a physical computing system.

Method 400 begins at step 402, where entity-to-vector process 108 obtains a graph description of entities in a computing system. In an embodiment., entity-to-vector process 108 can generate the graph description from tabular data (404). Alternatively, entity-to-vector process 108 can obtain the graph description directly from a graph database (406).

At step 408, entity-to-vector process 108 extracts a set of paths from the graph description. In an embodiment, the set of paths consist of all possible paths in the graph description (e.g., a corpus of paths). Each path includes a plurality of the nodes in the graph connected in series by edges.

At step 410, entity-to-vector process 108 selects one or more entities to translate into a vector representation. In an embodiment, entity-to-vector process 108 selects all entities and processes them in parallel. However, in other embodiments, less than all entities can be selected. At step 412, entity-to-vector process 108 generates vector descriptions of the selected entities using an algorithm that uses the set of paths as training data. Example algorithms are listed above. The vector description comprises a set of elements. In an embodiment, the elements in the vector description are numbers (e.g., real numbers, integers, etc.). At step 414, entity-to-vector process 108 determines whether additional entities should be processed (e.g., if in an embodiment where less than all were selected at step 410). If so, method 400 returns to step 410 and repeats for the additional entities. Otherwise, method 400 proceeds to step 416. Method 400 can be performed for one or more entities, including all entities, in the graph description. At step 416, application 110 processes the vector description(s) using mathematical model 212 to perform a function (e.g., classification, anomaly detection, clustering, etc.)

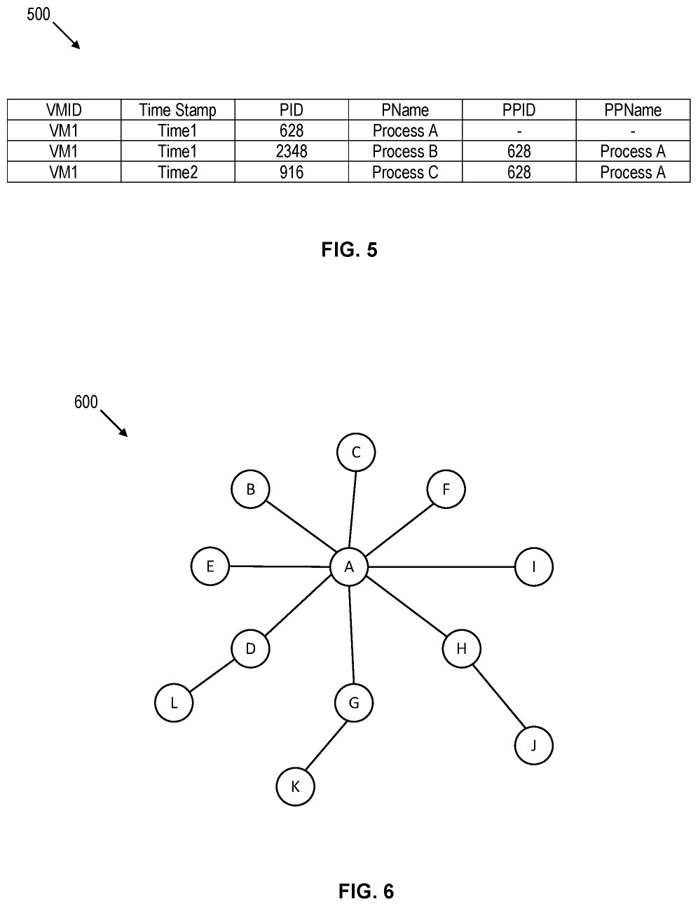

FIGS. 5-8 illustrate an example entity-to-vector translation for a set of processes in a computer system according to an embodiment. FIG. 5 shows a table 500 of processes and corresponding metadata. In the example table, each process has a VMID identifying the VM in which the processes is executing, a timestamp indicating when the process was invoked, a process ID (PID), a process name (PName), a parent process ID (PPID), and a parent process name (PPname). In the example shown, process A is a root process that spawns processes B and C.

FIG. 6 depicts an invocation graph 600 for a set of processes according to an embodiment. Graph 600 includes a process A that invokes processes B through I. The process H invokes a process J; the process G invokes a process K; and the process D invokes the process L. Graph 600 is typical of a process invocation graph having one root process that spawns many other processes, some of which spawn still further processes. Paths can be extracted from invocation graph 600 as described above (e.g., [A B], [A C], [A H J], [A D L], etc.). The processes are then converted into vector representations using the set of paths as training data, as discussed above.

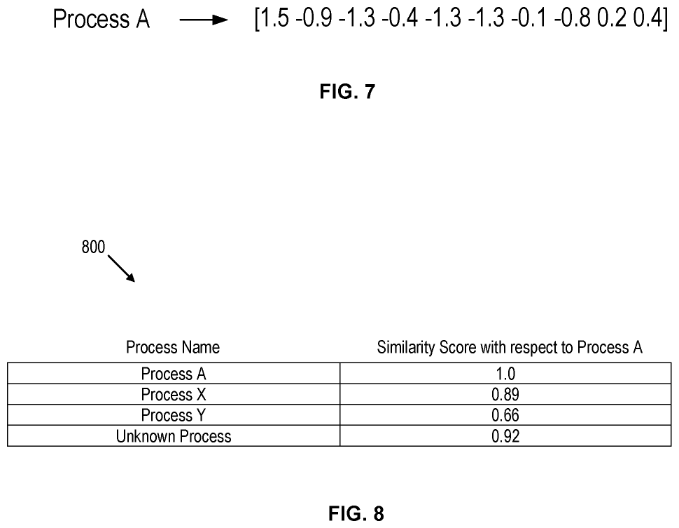

FIG. 7 depicts an example conversion of a process into a vector according to an embodiment. In the example, Process A is converted into a vector [1.5 −0.9 −1.3 −0.4 −1.3 −1.3 −0.1 −0.8 0.2 0.4]. In general, the vector can include any number of elements which can be integers, real numbers, etc. The vector generated depends on the algorithm used and the paths extracted from the invocation graph. FIG. 8 depicts a table 800 showing comparison of a process with other processes to determine similarity according to an example. As shown, Process A has a score of 1.0 indicating that the vector is identical (e.g., Process A is the same as the processing being compared). Process X has a score of 0.89, meaning that process X is very similar to the process being compared. Process Y has a score of 0.66, meaning that process Y is not as close to the process being compared as process X. The unknown process has a score of 0.92, meaning that this unknown process is very similar to the process being compared. In this manner, such an unknown process can be identified as likely being the compared process.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of representing a selected entity in a plurality of entities in a computing system, comprising:
obtaining a graph representation of the plurality of entities, the graph representation having nodes and edges representing a hierarchy of the plurality of entities;
extracting a set of paths from the graph representation, each path in the set of paths including a series of edge-connected nodes in the graph representation;
processing the set of paths to generate a vector representation of the selected entity, the vector representation having a plurality of elements representing a context of the selected entity within the graph representation; and
providing the vector representation as input to an application executing in the computing system.

2. The method of claim 1, wherein the step of obtaining comprises:
generating the graph representation from tabular data describing the plurality of entities.

3. The method of claim 1, wherein the step of obtaining comprises:
obtaining the graph representation from a graph database.

4. The method of claim 1, wherein the plurality of entities comprises at least one of a virtual machine (VM), an Internet Protocol (IP) address, and a process executable in the computing system.

5. The method of claim 1, wherein the application comprises at least one of a health monitor, an anomaly detector, a clustering tool, and a classification tool.

6. The method of claim 1, wherein the plurality of elements in the vector representation comprise a plurality of numbers, and wherein the application includes a mathematical model having the vector representation as parametric input.

7. The method of claim 1, wherein the set of paths consists of all possible paths in the graph representation.

8. A non-transitory computer readable medium comprising instructions to be executed in a computing device to cause the computing device to carry out a method of representing a selected entity in a plurality of entities in a computing system, comprising:
obtaining a graph representation of the plurality of entities, the graph representation having nodes and edges representing a hierarchy of the plurality of entities;
extracting a set of paths from the graph representation, each path in the set of paths including a series of edge-connected nodes in the graph representation;
processing the set of paths to generate a vector representation of the selected entity, the vector representation having a plurality of elements representing a context of the selected entity within the graph representation; and
providing the vector representation as input to an application executing in the computing system.

9. The non-transitory computer readable medium of claim 8, wherein the step of obtaining comprises:
generating the graph representation from tabular data describing the plurality of entities.

10. The non-transitory computer readable medium of claim 8, wherein the step of obtaining comprises:
obtaining the graph representation from a graph database.

11. The non-transitory computer readable medium of claim 8, wherein the plurality of entities comprises at least one of a virtual machine (VM), an Internet Protocol (IP) address, and a process executable in the computing system.

12. The non-transitory computer readable medium of claim 8, wherein the application comprises at least one of a health monitor, an anomaly detector, a clustering tool, and a classification tool.

13. The non-transitory computer readable medium of claim 8, wherein the plurality of elements in the vector representation comprise a plurality of numbers, and wherein the application includes a mathematical model having the vector representation as parametric input.

14. The non-transitory computer readable medium of claim 8, wherein the set of paths consists of all possible paths in the graph representation.

15. A computing system, comprising:
a hardware platform comprising a processor and a memory;
a software platform, implemented by instructions stored in the memory and executed by the processor, the software platform including an entity-to-vector application configured to represent a selected entity of a plurality of entities in the computing system by:
obtaining a graph representation of the plurality of entities, the graph representation having nodes and edges representing a hierarchy of the plurality of entities;
extracting a set of paths from the graph representation, each path in the set of paths including a series of edge-connected nodes in the graph representation;
processing the set of paths to generate a vector representation of the selected entity, the vector representation having a plurality of elements representing a context of the selected entity within the graph representation; and
providing the vector representation as input to an application executing in the computing system.

16. The computing system of claim 15, wherein entity-to-vector application is configured to obtain the graph representation by:
generating the graph representation from tabular data describing the plurality of entities.

17. The computing system of claim 15, wherein entity-to-vector application is configured to obtain the graph representation by:
obtaining the graph representation from a graph database.

18. The computing system of claim 15, wherein the plurality of entities comprises at least one of a virtual machine (VM), an Internet Protocol (IP) address, and a process executable in the computing system.

19. The computing system of claim 15, wherein the application comprises at least one of a health monitor, an anomaly detector, a clustering tool, and a classification tool.

20. The computing system of claim 15, wherein the plurality of elements in the vector representation comprise a plurality of numbers, and wherein the application includes a mathematical model having the vector representation as parametric input.
